(19) United States
(12) Patent Application Publication
(10) Pub. No.: US 2025/0167897 A1
(43) Pub. Date: May 22, 2025

(54) RECEIVING METHOD, SYNCHRONIZATION DEVICE AND RECEIVING APPARATUS

(71) Applicant: NIPPON TELEGRAPH AND TELEPHONE CORPORATION, Tokyo (JP)

(72) Inventors: Hiroyuki FUKUMOTO, Musashino-shi (JP); Yosuke FUJINO, Musashino-shi (JP); Seiji OMORI, Musashino-shi (JP); Yuya ITO, Musashino-shi (JP); Miharu OIWA, Musashino-shi (JP); Ryota OKUMURA, Musashino-shi (JP)

(73) Assignee: NIPPON TELEGRAPH AND TELEPHONE CORPORATION, Tokyo (JP)

(21) Appl. No.: 18/838,461

(22) PCT Filed: Mar. 11, 2022
(86) PCT No.: PCT/JP2022/011108

§ 371 Date: Aug. 14, 2024

(51) Int. Cl. H04B 11/00; H04L 5/00; H04L 25/02

(52) U.S. Cl. CPC H04B 11/00; H04L 5/0044; H04L 25/0204

(57) ABSTRACT

The synchronization device includes detecting units, a calculation unit, correcting units, a Doppler estimation unit, and offsetting units. The detecting units detect a position of the first sequence and a position of the second sequence in the received signal of each of the plurality of channels received by the plurality of reception units. The calculation unit calculates a time period required to receive a predetermined part of the received signal of each channel on the basis of the detected positions. The correcting unit performs a correcting process of correcting one or both of an outlier included in the position of the first sequence of each channel and an outlier included in the time period calculated for each channel. The Doppler estimation unit estimates Doppler shift by using the time period after the correcting process for each channel. The offsetting unit offsets the received signal by using the Doppler shift for each channel and outputs the received signal divided on the basis of the position of the first sequence after the correcting process to an equalizer.

### TECHNICAL FIELD

The present invention relates to a receiving method, a synchronization device and a receiving apparatus.

### BACKGROUND ART

In water, absorption and attenuation of radio waves are extremely large, and thus it is difficult to perform wireless communication using radio waves as on land. In this respect, in water, sound waves of 1 MHz or lower are often used for wireless communication. The sound waves are relatively less likely to be absorbed and attenuated even in water. Wireless communication in water using sound waves may be referred to as underwater acoustic communication. The sound waves have a slow propagation velocity. Therefore, a large Doppler shift may occur in the sound waves as a terminal moves. Further, an undersea environment is a multipath environment. Hence, multipath with the Doppler shift may occur.

The Doppler shift causes a sampling timing shift. When the sampling timing shift is accumulated and the total amount of the sampling timing shift exceeds a time period corresponding to one symbol, a burst error due to slip occurs. FIG. 13 is a diagram illustrating a specific example of burst errors due to slip. FIG. 13 illustrates an example in which a sample interval A1 is larger than a modulation rate. Slip occurs at a point represented by reference sign A2 due to accumulation of sampling timing shift. After the slip occurs, errors of received data continue to be produced.

In underwater communication that is likely to be adversely affected by multipath, an equalizing process by a plurality of reception channels may be used. For the equalizing process, for example, a multi-channel decision feedback equalizer (multi-channel DFE (MDFE)) is used (see, for example, Non Patent Literature 1). The multi-channel DFE internally includes a finite impulse response (FIR) filter for each channel. When the sampling timing shift occurs due to the Doppler shift as illustrated in FIG. 13, a coefficient of the FIR filter is offset from the optimum value in a time axis direction. Therefore, it is necessary to relearn the coefficient of the FIR filter to correct the sampling timing shift. However, even if relearning of the coefficient of the filter is performed for each symbol, the relearning of the filter may not be in time and slip may occur. In this case, since the coefficient of the filter diverges, waveform equalization may fail.

In this respect, in the underwater acoustic communication, a synchronization unit may be provided at a preceding stage of an input to an equalizer, and the sampling timing shift due to the Doppler shift may be corrected in advance (see, for example, Non Patent Literature 1). The synchronization unit performs synchronization processing on the Doppler shift and detection of a head position of a data frame for each reception channel. By correcting a sample rate and a phase rotation amount of a received signal in advance in a range in which the offset due to the Doppler shift can be tracked, the coefficient of the filter can easily converge, and the slip can be prevented. In addition, the multipath combination effect improves when the head position is correctly detected. Consequently, a received signal-to-noise ratio (SNR) at an equalizer output improves.

FIG. 14 is a diagram illustrating a functional block of a receiver 87 using a conventional technology. FIG. 14 particularly illustrates a configuration disclosed in Non Patent Literature 2 as an example. The receiver 87 includes a wave receiver 88 having two or more channels. An analog-to-digital converter (ADC) 89 of each channel converts an input from the wave receiver 88 from an analog signal to a digital signal. A synchronization unit 90 is provided at a preceding stage of an equalizer 99. The equalizer 99 is a multi-channel DFE equalizer. The equalizer 99 receives a received signal corrected by the synchronization unit 90 provided for each channel.

FIG. 15 is a diagram illustrating a configuration of the synchronization unit 90 individually provided for each channel. The synchronization unit 90 includes an estimation unit 91, a resampling unit 92, and a phase rotation unit 93. The estimation unit 91 estimates a Doppler shift amount and a frame head timing of a reception channel. The resampling unit 92 corrects a sampling timing on the basis of a Doppler estimated value which is the Doppler shift amount estimated by the estimation unit 91. The phase rotation unit 93 applies phase rotation to the received signal on the basis of the Doppler estimated value in the estimation unit 91. The equalizer 99 starts the equalizing process from the frame head timing of the reception channel estimated by the estimation unit 91.

A frame of the received signal is configured to have a preamble portion and a postamble portion before and after a payload unit. The preamble portion and the postamble portion have signals of a known preamble sequence and a known postamble sequence, respectively, in the device on a reception side.

FIG. 16 is a diagram illustrating a functional block of an estimation unit 91 using a conventional technology. FIG. 16 particularly illustrates a configuration disclosed in Non Patent Literature 2 as an example. The estimation unit 91 includes a first correlator 911, a second correlator 912, a preamble position detecting unit 913, a postamble position detecting unit 914, a subtractor 915, and a Doppler estimation unit 916. The first correlator 911 calculates a correlation between a received signal and a preamble sequence. The second correlator 912 calculates a correlation between the received signal and a postamble sequence. The first correlator 911 and the second correlator 912 estimate delay profiles before and after a frame.

FIG. 17 is a diagram illustrating an outline of processing of the estimation unit 91 using the conventional technology. The preamble position detecting unit 913 detects an insertion position of a preamble portion in the received signal on the basis of a peak (maximum value) position B11 of an absolute value in the delay profile estimated by the first correlator 911. The postamble position detecting unit 914 detects an insertion position of a postamble portion in the received signal on the basis of a peak (maximum value) position B12 of an absolute value in the delay profile estimated by the second correlator 912.

The subtractor 915 calculates a temporal difference between the insertion position of the preamble portion detected by the preamble position detecting unit 913 and the insertion position of the postamble portion detected by the postamble position detecting unit 914. Based on the calculated temporal difference, the subtractor 915 obtains an elapsed time period Tᵣₚ from a start point of the preamble portion to a start point of the postamble portion. The Doppler estimation unit 916 estimates Doppler shift by calculating an expansion/contraction ratio Tₜₚ/Tᵣₚ of the frame by using the elapsed time period Tₜₚ from the head of the preamble portion to the head of the postamble portion at the time of transmission and an elapsed time period Tᵣₚ at the time of reception. The synchronization unit 90 inputs the received signal obtained after the Doppler shift correction by the phase rotation unit 93 to the equalizer 99, with the peak position B11 detected by the preamble position detecting unit 913 as the head position of the received signal.

However, in an underwater environment that is likely to be adversely affected by multipathing, estimation of the Doppler shift may fail. In water, the intensity of multipath waves and the Doppler shift amount are likely to fluctuate in both a temporal direction and a spatial direction in a short cycle due to fluctuation of a water surface or oscillation of a receiving apparatus. Hence, the absolute value of each path in the estimated delay profile is likely to be reversed (for example, see Non Patent Literature 3).

FIG. 18 is a diagram schematically illustrating a reversal phenomenon as described in Non Patent Literature 3. FIG. 18(a) is a diagram illustrating a specific example of a frame configuration of a received signal that is a processing target. FIG. 18(b) is a diagram illustrating a specific example of an estimation result in a situation not affected by multipathing. A situation that is not affected by the multipathing is, for example, a case of a single-wave transmission path. In this situation, the Doppler shift is estimated similarly to FIG. 17. The elapsed time period Tᵣₚ′ from the start point of the preamble portion to the start point of the postamble portion which is to be estimated coincides with an elapsed time period Tᵣₚ from a start point B21 of a preamble portion detected by the preamble position detecting unit 913 to a start point B22 of a postamble portion detected by the postamble position detecting unit 914.

FIG. 18(c) is a diagram illustrating a specific example of an estimation result in a case where the reversal phenomenon occurs under the influence of multipathing. For example, this reversal phenomenon occurs in the case of a propagation path with a level-varying multipath wave. In FIG. 18 (c), regarding the preamble, a level of a direct wave W1 is higher than a level of a multipath wave W2. However, due to a level variation B32 of a multipath wave, regarding the postamble, the level of the multipath wave W2 is higher than the level of the direct wave W1. When this reversal phenomenon occurs, a path in which a peak of the preamble portion is detected does not coincide with a path in which a peak of the postamble portion is detected. That is, a peak position B31 of the direct wave W1 is detected in the preamble, and a peak position B33 of the multipath wave W2 is detected in the postamble. When the same path is not detected, the Doppler shift is not correctly estimated. The elapsed time period Tᵣₚ from the start point B31 of the preamble portion to the start point B33 of the postamble portion is different from the elapsed time period Tᵣₚ′ to be estimated. As a result, the accuracy of correction is reduced. Rather, as a result of applying erroneous correction to the received signal, the sampling timing shift further increases, and equalization fails.

Similarly, a reversal phenomenon may occur in the spatial direction. FIG. 19 is a diagram schematically illustrating a case where a spatial reversal phenomenon occurs. Two channels are referred to as channels Ch(1) and Ch(2). FIG. 19(a) is a diagram illustrating a specific example of a frame configuration of a received signal that is a processing target. FIG. 19(b) illustrates a delay profile of the channel Ch(1), and FIG. 19(c) illustrates a delay profile of the channel Ch(2).

As illustrated in FIG. 19(b), at the channel Ch(1), a direct wave W11 is stronger than a multipath wave W12 such as a reflected wave. In a preamble of the channel Ch(1), a peak position B41 of the direct wave W11 is detected. On the other hand, as illustrated in FIG. 19(c), at the channel Ch(2), the multipath wave W12 is stronger than the direct wave W11. In the preamble of the channel Ch(2), a peak position B42 of the multipath wave W12, which is a path different from the channel Ch(1), is detected. When the reversal phenomenon occurs in this manner, the path detected at the channel Ch(1) and a path detected at the channel Ch(2) do not coincide. As a result, the received signal is input to the equalizer 99 at a different timing for each channel. As a result of received signals being input to the equalizer 99 at different positions, direct waves cannot be effectively combined, and thus the SNR of the equalizer output is lowered.

### CITATION LIST

### Non Patent Literature

Non Patent Literature 1: M. Johnson, L. Freitag and M. Stojanovic, “Improved Doppler tracking and correction for underwater acoustic communications,” 1997 IEEE International Conference on Acoustics, Speech, and Signal Processing, 1997, pp. 575-578 vol. 1, doi: 10.1109/ICASSP.1997.599703.
Non Patent Literature 2: B. S. Sharif, J. Neasham, O. R. Hinton and A. E. Adams, “A computationally efficient Doppler compensation system for underwater acoustic communications,” in IEEE Journal of Oceanic Engineering, vol. 25, no. 1, pp. 52-61, January 2000, doi: 10.1109/48.820736.
Non Patent Literature 3: M. Stojanovic and J. Preisig, “Underwater acoustic communication channels: Propagation models and statistical characterization,” in IEEE Communications Magazine, vol. 47, no. 1, pp. 84-89, January 2009, doi: 10.1109/MCOM.2009.4752682.

### SUMMARY OF INVENTION

### Technical Problem

As described above, in a multipath environment involving a change in the Doppler shift such as an underwater environment, estimation of the Doppler shift or detection accuracy of a frame head position may be degraded, and errors of received data may increase.

In view of the above circumstances, objects of the present invention are to provide a receiving method, a synchronization device and a receiving apparatus capable of reducing errors in received data even in a multipath environment involving a change in Doppler shift.

### Solution to Problem

A receiving method of one aspect of the present invention includes: a detecting step of detecting a position of a first sequence and a position of a second sequence in a received signal of each of a plurality of channels received by a plurality of reception units; a calculating step of calculating, for each of the plurality of channels, a time period required to receive a predetermined part of the received signal, based on the detected position of the first sequence and the detected position of the second sequence; a correcting step of performing a correcting process of correcting one or both of an outlier included in the position of the first sequence estimated for each of the plurality of channels and an outlier included in the time period calculated for each of the plurality of channels; a Doppler estimating step of estimating Doppler shift by using the time period after the correcting process for each of the plurality of channels; and an offsetting step of offsetting the received signal by using the estimated Doppler shift for each of the plurality of channels and outputting the received signal divided based on the position of the first sequence after the correcting process to an equalizer.

A synchronization device of another aspect of the present invention includes: a detecting unit that detects a position of a first sequence and a position of a second sequence in a received signal of each of a plurality of channels received by a plurality of reception units; a calculation unit that calculates, for each of the plurality of channels, a time period required to receive a predetermined part of the received signal, based on the detected position of the first sequence and the detected position of the second sequence; a correcting unit that performs a correcting process of correcting one or both of an outlier included in the position of the first sequence estimated for each of the plurality of channels and an outlier included in the time period calculated for each of the plurality of channels; a Doppler estimation unit that estimates Doppler shift by using the time period after the correcting process for each of the plurality of channels; and an offsetting unit that offsets the received signal by using the estimated Doppler shift for each of the plurality of channels and outputs the received signal divided based on the position of the first sequence after the correcting process to an equalizer.

A receiving apparatus of still another aspect of the present invention includes: a plurality of reception units that receive signals of different individual channels; a detecting unit that detects a position of a first sequence and a position of a second sequence in a received signal of each of a plurality of the channels received by the plurality of reception units; a calculation unit that calculates, for each of the plurality of channels, a time period required to receive a predetermined part of the received signal, based on the detected position of the first sequence and the detected position of the second sequence; a correcting unit that performs a correcting process of correcting one or both of an outlier included in the position of the first sequence estimated for each of the plurality of channels and an outlier included in the time period calculated for each of the plurality of channels; a Doppler estimation unit that estimates Doppler shift by using the time period after the correcting process for each of the plurality of channels; an offsetting unit that offsets the received signal by using the estimated Doppler shift for each of the plurality of channels and outputs the received signal divided based on the position of the first sequence after the correcting process; and an equalization unit that performs an equalizing process by using the received signal of each of the plurality of channels output from the offsetting unit.

### Advantageous Effects of Invention

According to the present invention, it is possible to reduce errors of received data even in a multipath environment involving a change in Doppler shift.

### BRIEF DESCRIPTION OF DRAWINGS

FIG. 1 is a diagram illustrating a configuration of a receiver according to an embodiment of the present invention.

FIG. 2 is a diagram illustrating a relationship between a reception channel number and an estimated value.

FIG. 3 is a diagram illustrating a configuration of a synchronization unit according to the embodiment.

FIG. 4 is a diagram illustrating a configuration of an estimation unit according to the embodiment.

FIG. 5 is a diagram illustrating a configuration of a primary estimation unit according to the embodiment.

FIG. 6 is a diagram illustrating operations performed using outlier correction algorithms of a first outlier correcting unit and a second outlier correcting unit according to the embodiment.

FIG. 7 is a flowchart of the outlier correction algorithm according to the embodiment.

FIG. 8 is a schematic diagram of an experiment.

FIG. 9 is a diagram illustrating experimental data.

FIG. 10 is a diagram illustrating an estimated value of a frame head timing.

FIG. 11 is a diagram illustrating Doppler estimated value.

FIG. 12 is a diagram illustrating an SNR characteristic in an output of an equalizer.

FIG. 13 is a diagram illustrating an example of burst errors due to slip.

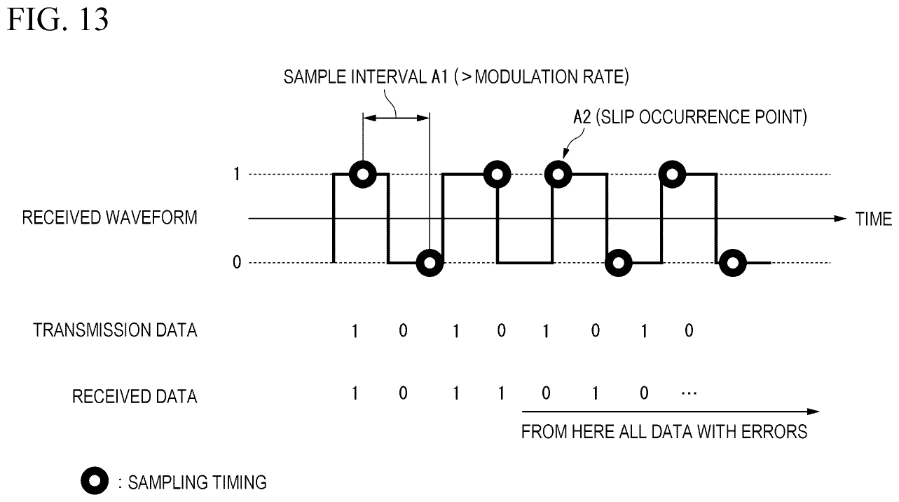

FIG. 14 is a diagram illustrating a functional block of a receiver using a conventional technology.

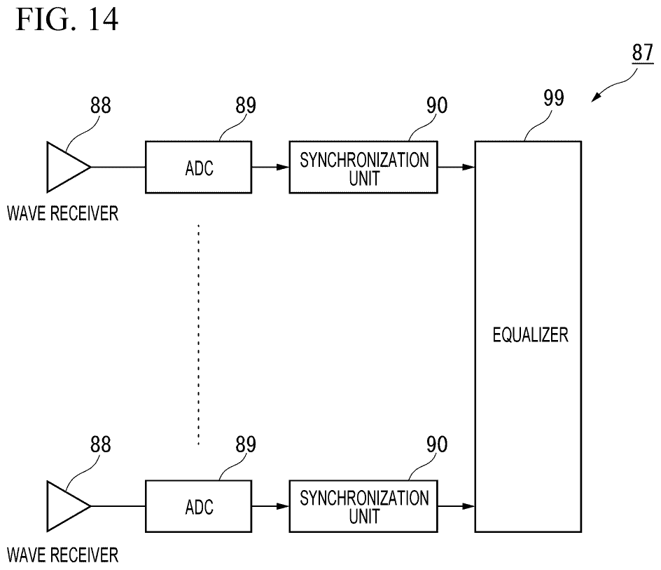

FIG. 15 is a diagram illustrating a configuration of a synchronization unit using a conventional technology.

FIG. 16 is a diagram illustrating a functional block of an estimation unit using a conventional technology.

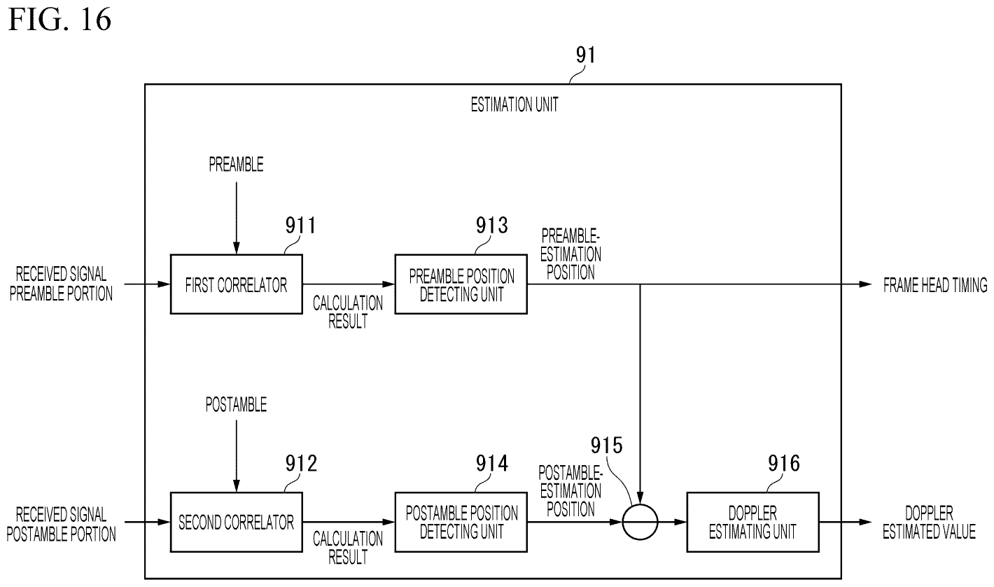

FIG. 17 is a diagram illustrating an outline of processing of the estimation unit using the conventional technology.

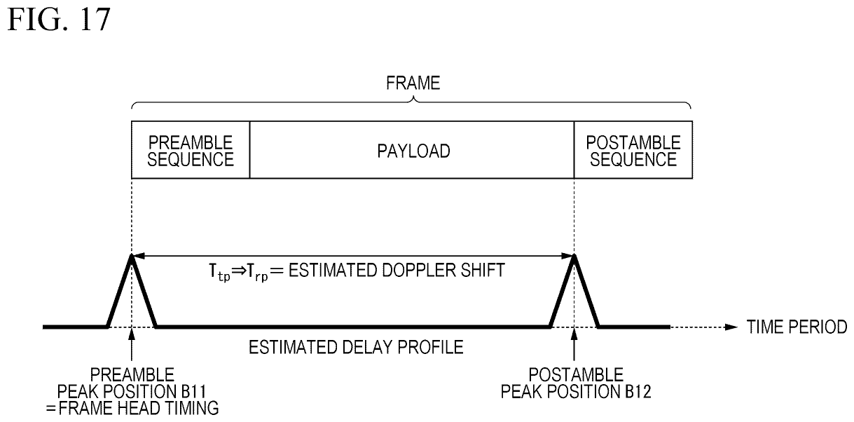

FIG. 18 is a diagram schematically illustrating a reversal phenomenon in a delay profile.

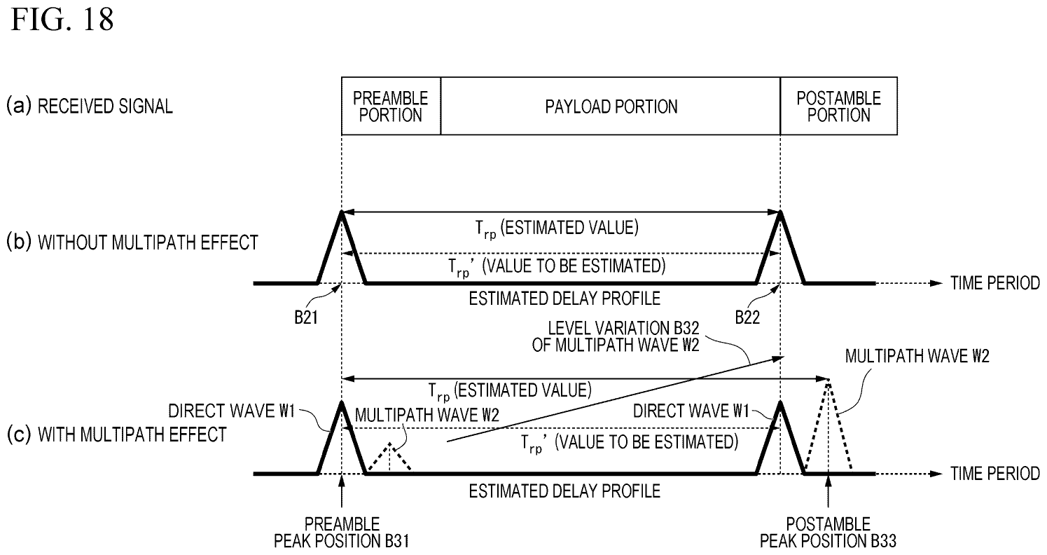

FIG. 19 is a diagram schematically illustrating a case where a spatial reversal phenomenon occurs.

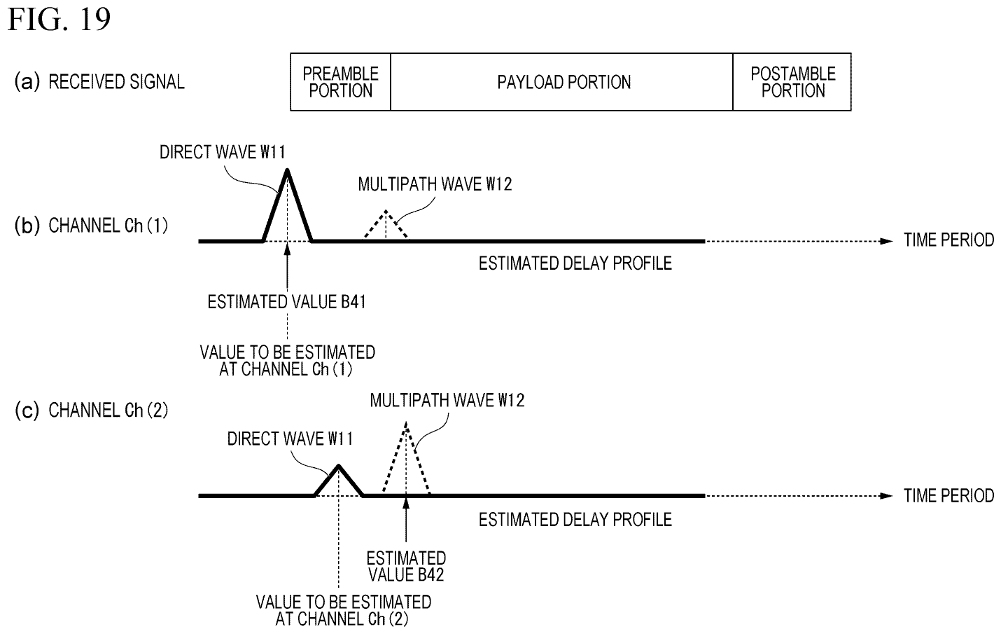

### DESCRIPTION OF EMBODIMENTS

Hereinafter, embodiments of the present invention will be described in detail with reference to the drawings.

### [Configuration of Receiver]

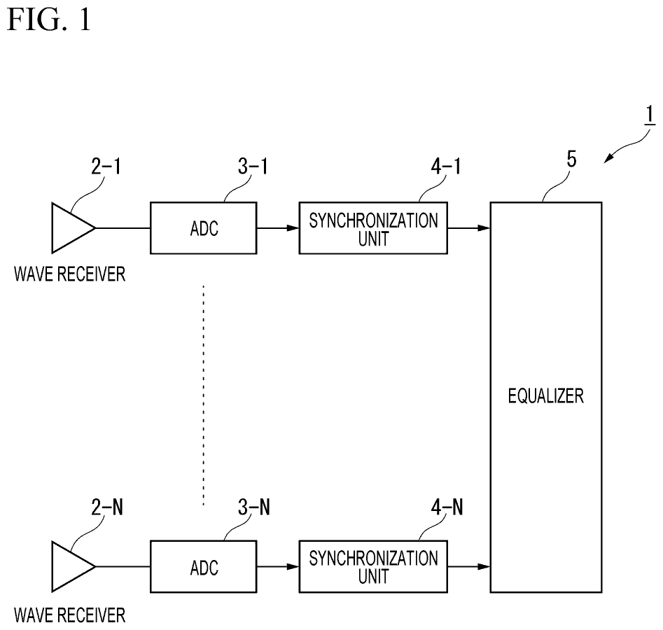

First, a configuration of a receiver according to an embodiment of the present invention is described. FIG. 1 is a diagram illustrating a configuration of a receiver 1 of an acoustic communication system used in the present embodiment. The receiver 1 includes a wave receiver 2, an analog to digital converter (ADC) 3, a synchronization unit 4, and an equalizer 5. The receiver 1 has an array of two or more channels. That is, the receiver 1 includes sets of the wave receiver 2, the ADC 3, and the synchronization unit 4 as many as the number N of channels. N is an integer of 2 or more. An n-th reception channel is referred to as a channel Ch(n), and the wave receiver 2, the ADC 3, and the synchronization unit 4 corresponding to the channel Ch(n) are referred to as a wave receiver 2-n, an ADC 3-n, and a synchronization unit 4-n, respectively. Here, n is an integer of 1 or more and N or less.

As described above, the receiver 1 includes wave receivers 2 of two or more channels. The wave receiver 2 receives a sound wave propagating in water. Wave receivers 2-1 to 2-N are regularly arranged like an array antenna. The receiver 1 obtains a relative positional relationship between the wave receivers 2 in advance. The ADC 3-n converts data received by the wave receiver 2-n from analog data to digital data. The receiver 1 synchronizes the received data by the synchronization units 4-1 to 4-N and outputs synchronized data to the equalizer 5. The equalizer 5 is, for example, a multi-channel DFE type equalizer. The equalizer 5 equalizes the received data received from each of the synchronization units 4-1 to 4-N and then obtains a demodulation result. The receiver 1 performs received signal processing of each channel by using digital signal processing.

### [Principle of Present Embodiment]

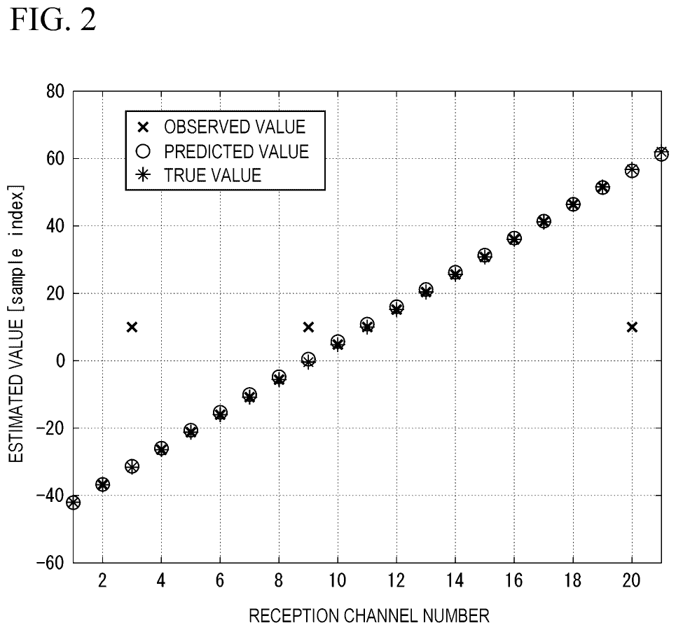

Here, effects of the robust regression, which is the origin of the idea of the present invention, will be described for an understanding of an operation principle of a device. FIG. 2 is a diagram illustrating a relationship between a reception channel number and an estimated value. A cross mark indicates an observed value, and a star mark indicates a true value. The observed value is, for example, a Doppler estimated value. As illustrated in FIG. 2, reception channels Ch(3), Ch(9), and Ch(20) are observed at positions shifted from the originally expected true values. On the other hand, regarding the other channels, true values are correctly estimated. A circle indicates a result of prediction using an iterative reweighted least square (IRLS) method as the robust regression. By the IRLS method, erroneous estimation is corrected on the basis of information of other reception channels. As a result, an outlier included in an observed value can be corrected. By applying the present principle to an estimation unit 41 to be described below included in the synchronization unit 4, estimation accuracy can be enhanced. Details of a technique used for correcting the outlier are described, for example, in Reference Literature 1.
(Reference Literature 1) WADA, “Detection of Multivariate Outliers—Regression Imputation by the Iteratively Reweighted Least Squares—”, Statistical Research Bulletin, No. 69, March 2012, pp. 23-52

### [Configuration of Synchronization Unit According to Embodiment]

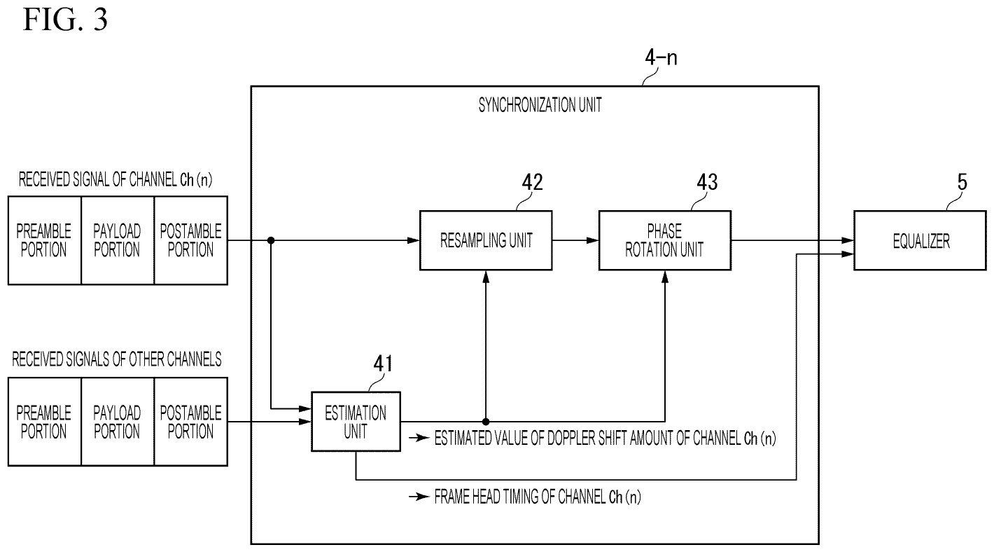

FIG. 3 is a diagram illustrating a configuration of the synchronization unit 4-n. The synchronization unit 4-n includes an estimation unit 41, a resampling unit 42, and a phase rotation unit 43. Note that the estimation unit 41 may be provided outside the synchronization unit 4-n. In addition, all or some of the synchronization units 4-1 to 4-N may share one estimation unit 41.

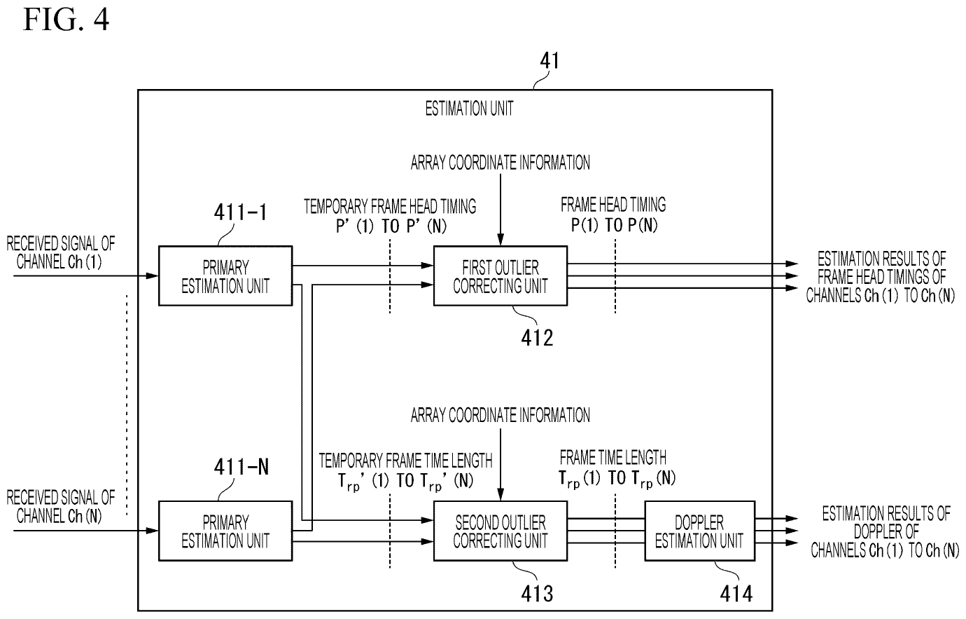

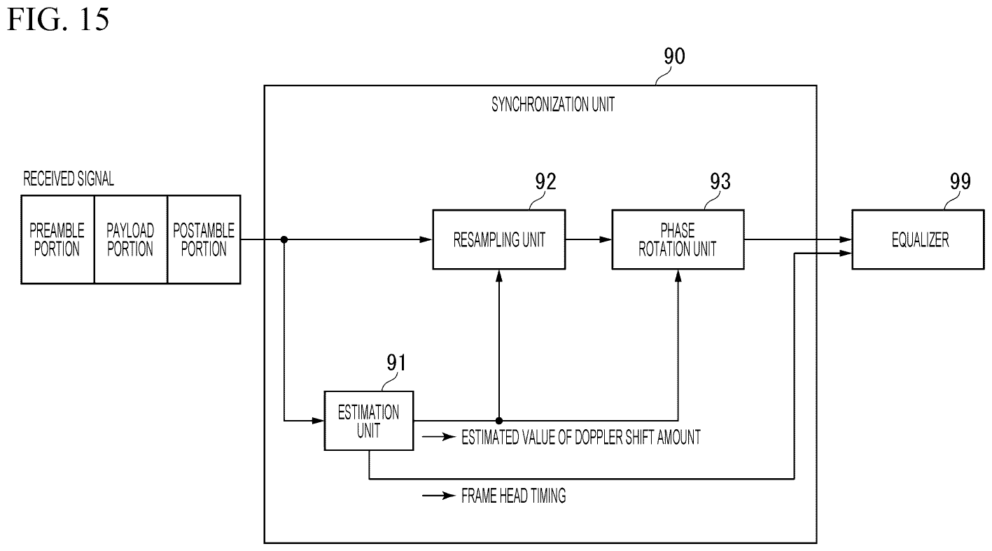

The estimation unit 41 estimates a Doppler shift amount and a frame head timing of each of the channels Ch(1) to Ch(N) on the basis of the received signal of each of the channels Ch(1) to Ch(N). A frame of the received signal is configured to have a preamble portion and a postamble portion before and after a payload unit. The preamble portion includes a preamble that is a known data sequence, and the postamble portion includes a postamble that is a known data sequence. Details of the estimation unit 41 will be described below with reference to FIG. 4. The resampling unit 42 and the phase rotation unit 43 have functions similar to those of the resampling unit 92 and the phase rotation unit 93 illustrated in FIG. 15, respectively. That is, the resampling unit 42 corrects a sampling timing of the received signal of the channel Ch(n) on the basis of a Doppler estimated value which is an estimated Doppler shift amount of the channel Ch(n) in the estimation unit 41. The phase rotation unit 43 applies phase rotation for offsetting a Doppler shift on the basis of the Doppler estimated value of the channel Ch(n) in the estimation unit 41 to the received signal of the channel Ch(n) sampled by the resampling unit 42. The synchronization unit 4-n uses the frame head timing of the channel Ch(n) detected by the estimation unit 41 as a head position of the received signal and inputs the received signal obtained after phase offset by the phase rotation unit 43 to the equalizer 5.

FIG. 4 is a diagram illustrating a configuration of the estimation unit 41. The estimation unit 41 includes N primary estimation units 411 for respective channels, a first outlier correcting unit 412 and a second outlier correcting unit 413 following the primary estimation units 411, and a Doppler estimation unit 414. The N primary estimation units 411 are referred to as primary estimation units 411-1 to 411-N. The T primary estimation unit 411-n receives the received signal of the channel Ch(n) converted into a digital signal by the ADC 3, as an input. The primary estimation unit 411-n estimates the frame head timing of the input received signal and a frame time length at a time point of reception of the received signal. The frame head timing and the frame time length estimated by the primary estimation unit 411-n are referred to as a temporary frame head timing P′ (n) and a temporary frame time length T′ᵣₚ(n), respectively.

The first outlier correcting unit 412 uses temporary frame head timings P′ (1) to P′ (N) of all the channels Ch(1) to Ch(N) to correct the outliers by, for example, a robust regression method. The first outlier correcting unit 412 obtains estimated frame head timings P(1) to P(N) of the respective channels Ch(1) to Ch(N) by correcting the outliers. The first outlier correcting unit 412 outputs the estimated frame head timings P(1) to P(N) of the respective channels Ch(1) to Ch(N) as estimation results.

The second outlier correcting unit 413 uses temporary frame time lengths Tᵣₚ′ (1) to Tᵣₚ′ (N) of all the channels Ch(1) to Ch(N) to correct the outliers by, for example, the robust regression method. The second outlier correcting unit 413 obtains estimated frame time lengths Tᵣₚ(1) to Tᵣₚ(N) of the respective channels Ch(1) to Ch(N) by correcting the outliers.

The Doppler estimation unit 414 receives the frame time lengths Tᵣₚ(1) to Tᵣₚ(N) of the respective channels Ch(1) to Ch(N) estimated by the second outlier correcting unit 413. The Doppler estimation unit 414 obtains an estimated value of a Doppler shift by calculating an expansion/contraction ratio Tₜₚ(n)/Tᵣₚ(n) of a frame for each channel Ch(n). Tₜₚ(n) represents an elapsed time period from a head of the preamble portion to a head of the postamble portion at the time of transmission of the received signal of the channel (n). The Doppler estimation unit 414 outputs a Doppler estimation result indicating an estimated value of the Doppler shift of the channel Ch(n) to the resampling unit 42 and the phase rotation unit 43 of the synchronization unit 4-n.

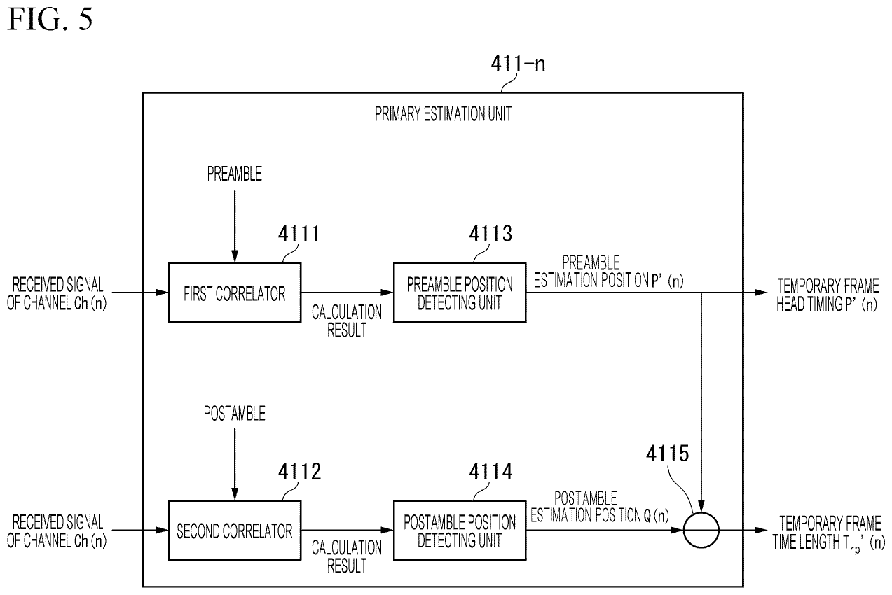

FIG. 5 is a diagram illustrating a configuration of the primary estimation unit 411-n. The primary estimation unit 411-n includes a first correlator 4111, a second correlator 4112, a preamble position detecting unit 4113, a postamble position detecting unit 4114, and a subtractor 4115.

The first correlator 4111 estimates a delay profile of the preamble by calculating a correlation between the received signal of the channel Ch(n) and the known preamble sequence. The second correlator 4112 estimates a delay profile of the postamble by calculating a correlation between the received signal of the channel Ch(n) and the known postamble sequence.

The preamble position detecting unit 4113 estimates an insertion position of the preamble portion by detecting a peak of the delay profile obtained by the first correlator 4111. The preamble position detecting unit 4113 sets the estimation result as a preamble insertion position P′ (n). The preamble insertion position P′ (n) is represented by, for example, a countervalue representing a time point when the detected peak is received. The preamble position detecting unit 4113 outputs the preamble insertion position P′ (n) as the temporary frame head timing P′ (n) to the first outlier correcting unit 412 of the estimation unit 41.

The postamble position detecting unit 4114 estimates a postamble insertion position Q (n), which is an insertion position of the postamble portion, by detecting a peak of the delay profile of the postamble obtained by the second correlator 4112. The postamble insertion position Q (n) is represented by, for example, a countervalue representing a time point when the detected peak is received. Note that the postamble position detecting unit 4114 may estimate the postamble insertion position Q (n) by any other conventional technology.

The subtractor 4115 calculates the temporary frame time length Tᵣₚ′ (n) of the received signal of the channel Ch(n) by calculating a temporal difference between the preamble insertion position P′ (n) estimated by the preamble position detecting unit 4113 and the postamble insertion position Q (n) estimated by the postamble position detecting unit 4114. The subtractor 4115 outputs the calculated temporary frame time length Tᵣₚ′ (n) to the second outlier correcting unit 413 of the estimation unit 41.

The primary estimation units 411-1 to 411-N perform the above-described operation for each channel individually.

Subsequently, the first outlier correcting unit 412 receives the temporary frame head timings P′ (1) to P′ (N) of the respective channels Ch(1) to Ch(N) as vector data. The first outlier correcting unit 412 performs regression analysis using the robust regression method and corrects data in which a direct wave and a reflected wave are erroneously recognized among the temporary frame head timings P′ (1) to P′ (N). The first outlier correcting unit 412 sets the corrected data as the frame head timings P(1) to P(N).

Similarly, the second outlier correcting unit 413 receives the temporary frame time lengths Tᵣₚ′ (1) to Tᵣₚ′ (N) of the respective channels Ch(1) to Ch(N) as vector data. The second outlier correcting unit 413 performs the regression analysis using the robust regression method and corrects data in which a direct wave and a reflected wave are erroneously recognized among the temporary frame time lengths Tᵣₚ′ (1) to Tᵣₚ′ (N). The second outlier correcting unit 413 sets the corrected data as the frame time lengths Tᵣₚ(1) to Tᵣₚ(N). The frame time length Tᵣₚ(n) is an estimated value of a time period required for reception from the head of the preamble portion to the head of the postamble portion of the received signal of the channel Ch(n).

Note that relative coordinates of each reception channel are used as explanatory variables of the regression analysis in each of the first outlier correcting unit 412 and the second outlier correcting unit 413.

The Doppler estimation unit 414 estimates a Doppler shift by calculating an expansion/contraction ratio Tₜₚ(n)/Tᵣₚ(n) of a frame on the basis of the elapsed time Tₜₚ(n) at the time of transmission and the estimated frame time length Tᵣₚ(n) at the time of reception for each channel Ch(n).

The estimated value for each of the channels Ch(1) to Ch(N) obtained by the above-described processing is set as the estimation result of the estimation unit 41.

Note that the first outlier correcting unit 412 and the second outlier correcting unit 413 may use an algorithm based on convex relaxation including the IRLS method, the least median square (LMedS) method, and the random sample consensus (RANSAC) method for data correction, may use a greedy method for the purpose of lp norm minimization, or may use a proximity gradient method for the purpose of lp norm minimization. Further, the first outlier correcting unit 412 and the second outlier correcting unit 413 may use ridge regression or logistic regression or may use least absolute shrinkage and selection operator (LASSO) regression, for data correction. In addition, any two or more robust regression methods described above may be used in combination. Further, the explanatory variable may be a linear function or an N-order function (N is 2 or more).

### [Example of Data Correction]

An example of specific processing of the first outlier correcting unit 412 and the second outlier correcting unit 413 will be described. An operation in a case where a first-order IRLS method is used as an outlier correction algorithm of the first outlier correcting unit 412 and the second outlier correcting unit 413 will be described.

A relative coordinate vector of the wave receiver 2 is a coordinate representing a point on a three-dimensional space (x, y, z) where the wave receiver 2 is disposed. For example, the wave receiver 2-n is disposed at (Xn, Yn, Zn) on the relative coordinates. The temporary estimation vector is a temporary frame head timing or a temporary frame time length, and pₙ is an estimated value for the received signal of the channel Ch(n). A weight W, a coefficient vector β, and a loss function f are used for calculation of the algorithm. The weight W is a diagonal matrix used in the calculation of the algorithm. The loss function f is used to determine the coefficient of W.

In the outlier correction algorithm, the following is used.

$$Relative coordinate vector of wave receiver : \\ X = {( {x}_{1} , … , {x}_{N} )}^{T} Y = {( {y}_{1} , … , {y}_{N} )}^{T} Z = {( {z}_{1} , … , {z}_{N} )}^{T} A = ( X , Y , Z , 1 ) \\ Temporary estimation vector : p = {( {p}_{1} , … , {p}_{N} )}^{T} \\ Weight : W ( j ) = {diag ( {w}_{e 1} , … , {w}_{eN} )}^{T} \\ Coefficient vector : β ( j ) = {( {β}_{x} , {β}_{y} , {β}_{z} , {β}_{b} )}^{T} \\ Loss function ( in case of Turkey weight ) : f ( e ) = \{ \begin{matrix}{\{ 1 - {( \frac{e}{c} )}^{2} \}}^{2} if \vert e \vert < c \\ 0 if \vert e \vert > c\end{matrix} \qquad [ Math . 1 ]$$

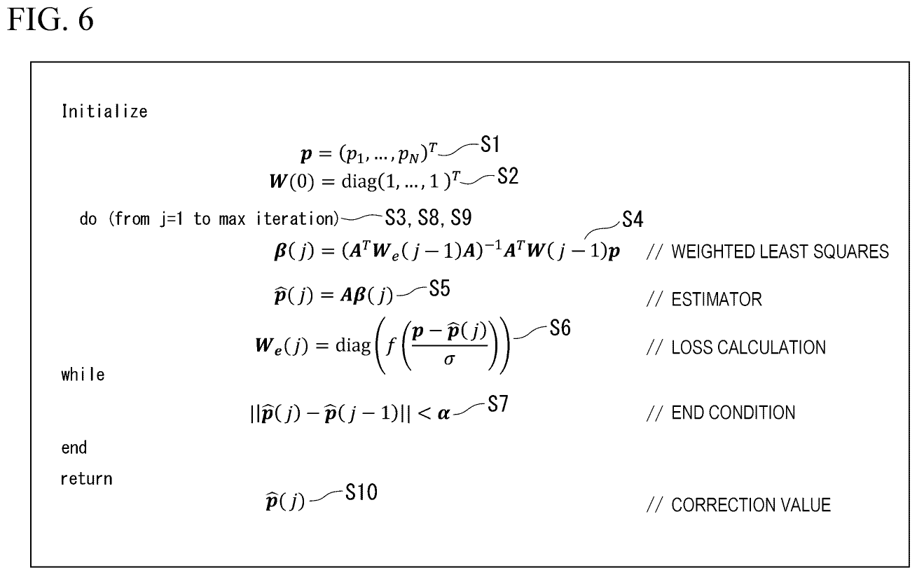

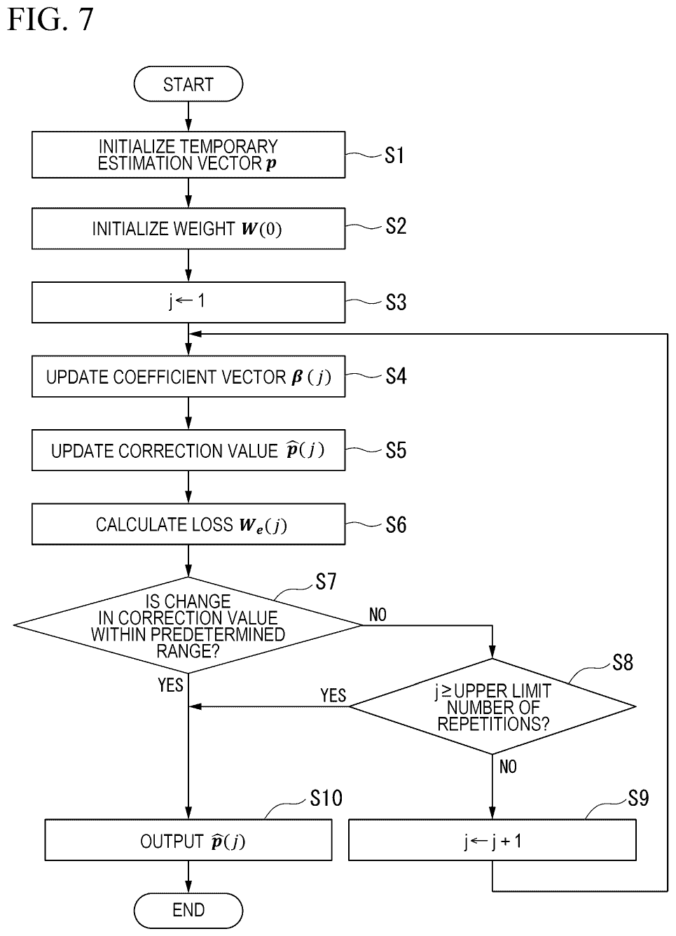

FIG. 6 is a diagram illustrating operations of the first outlier correcting unit 412 and the second outlier correcting unit 413 using the outlier correction algorithm. FIG. 7 is a flowchart of the outlier correction algorithm illustrated in FIG. 6. The operation of the outlier correction algorithm will be described with reference to FIGS. 6 and 7. Hereinafter, the case of the first outlier correcting unit 412 will be described as an example, and the second outlier correcting unit 413 operates in the same manner. Note that a sample standard deviation σ is a sample standard deviation obtained from sample values. In addition, p\hat{ } represents a correction value and is an output of the first outlier correcting unit 412.

The first outlier correcting unit 412 first performs initialization. The first outlier correcting unit 412 sets temporary frame head timings P′ (1) to P′ (N) for respective elements p₁ to p_{N} of a temporary estimation vector p (step S1). The first outlier correcting unit 412 sets 1 to elements of a diagonal matrix of a weight W(0) (step S2).

The first outlier correcting unit 412 initializes a variable j representing the number of repetitions to 1 (step S3). The first outlier correcting unit 412 performs the repetitive processing from step S4 to step S9 while increasing the value of j by 1 until the value of j reaches the upper limit number of repetitions.

First, the first outlier correcting unit 412 updates a coefficient vector β(j) as follows (step S4).

$$β ( j ) = {( {A}^{T} {W}_{e} ( j - 1 ) A )}^{- 1} {A}^{T} W ( j - 1 ) p \qquad [ Math . 2 ]$$

Subsequently, the first outlier correcting unit 412 updates the correction value p\hat{ } as follows (step S5).

$$\hat{p} ( j ) = A β ( j ) \qquad [ Math . 3 ]$$

Subsequently, the first outlier correcting unit 412 calculates a weight Wₑ(j) by using a current temporary estimation vector p and the correction value p\hat{ } calculated in step S5 as follows (step S6).

$${W}_{e} ( j ) = diag ( f ( \frac{p - \hat{p} ( j )}{σ} ) ) \qquad [ Math . 4 ]$$

The first outlier correcting unit 412 determines whether or not an update width of the correction value p\hat{ } falls within a predetermined range. Specifically, the first outlier correcting unit 412 determines whether or not the following end condition is satisfied (step S7). Here, α is a predetermined threshold value.

$$‖ \hat{p} ( j ) - \hat{p} ( j - 1 ) ‖ < α \qquad [ Math . 5 ]$$

In a case where the first outlier correcting unit 412 determines that the end condition is not satisfied (step S7: NO), the first outlier correcting unit 412 determines whether or not j has reached the upper limit number of repetitions (step S8). In a case where the first outlier correcting unit 412 determines that j has not reached the upper limit number of repetitions (step S8: NO), the first outlier correcting unit 412 adds 1 to j and repeats the processing from step S4 (step S9). In a case where the first outlier correcting unit 412 determines that the end condition is satisfied (step S7: YES) or in a case of determining that j has reached the upper limit number of repetitions (step S8: YES), the first outlier correcting unit 412 performs the processing of step S10. That is, the first outlier correcting unit 412 outputs the first to N-th elements of the correction value p\hat{ }(j) as the frame head timings P(1) to P(N), respectively (step S10).

In the case of the second outlier correcting unit 413, the temporary frame time lengths Tᵣₚ′ (1) to Tᵣₚ′ (N) are set for the elements p₁ to p_{N} of the temporary estimation vector p, respectively. In addition, the second outlier correcting unit 413 outputs the first to N-th elements of the correction value p\hat{ }(j) as the frame time lengths Tᵣₚ(1) to Tᵣₚ(N), respectively.

### [Effects]

Estimation and correction effects of the present embodiment are illustrated using experimental data acquired in an actual sea area.

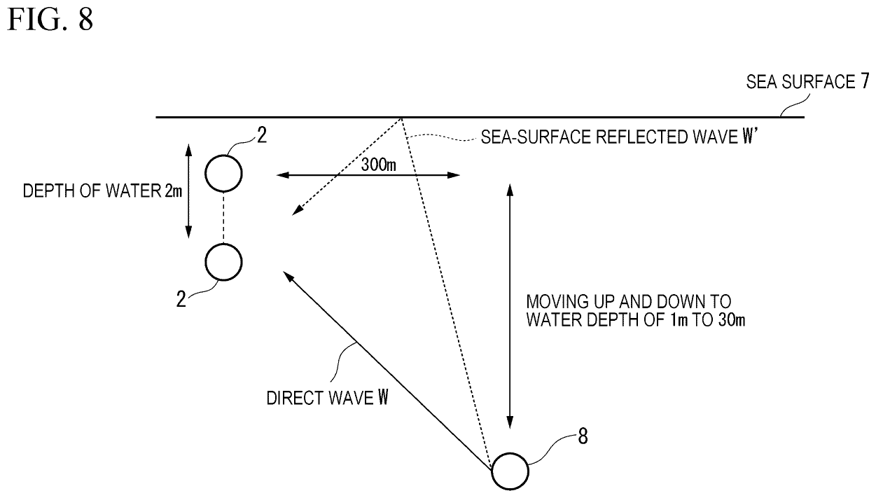

FIG. 8 is a schematic diagram of an experiment. In this experimental environment, there are a direct wave W and a sea-surface reflected wave W′. Further, a sea surface 7 always undulates. Therefore, the intensities of the reflected wave and the direct wave are frequently switched. A wave transmitter 8 had one element. The wave transmitter 8 was moved up and down at about 1 m/s between a water depth of 1 m and a water depth of 30 m so that a change in the Doppler shift and an arrival time of the direct wave W between the wave receivers 2 were changed from moment to moment. Meanwhile, the wave transmitter 8 continues sending test packets. At that time, the Doppler shift generated on the reception side falls within a range of ±7.28 Hz. The wave receiver 2 was a linear array of 16 elements. That is, the receiver 1 having 16 wave receivers 2 is used. The wave receiver 2 was fixedly installed at a water depth of 2 m. Element intervals between the wave receivers 2 was 10 cm. A signal received by the wave receiver 2 was recorded as digital data, and demodulation processing was performed on a computer to evaluate each characteristic thereof.

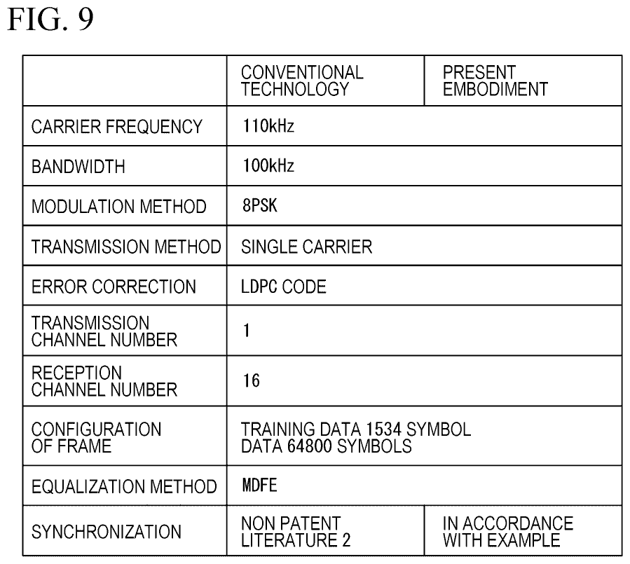

FIG. 9 is a diagram illustrating a table describing experimental data. Non Patent Literature 2 was used as the conventional technology. The above-described receiver 1 is used as the present embodiment. In the conventional technology and the present embodiment, all processes other than the synchronization method are the same.

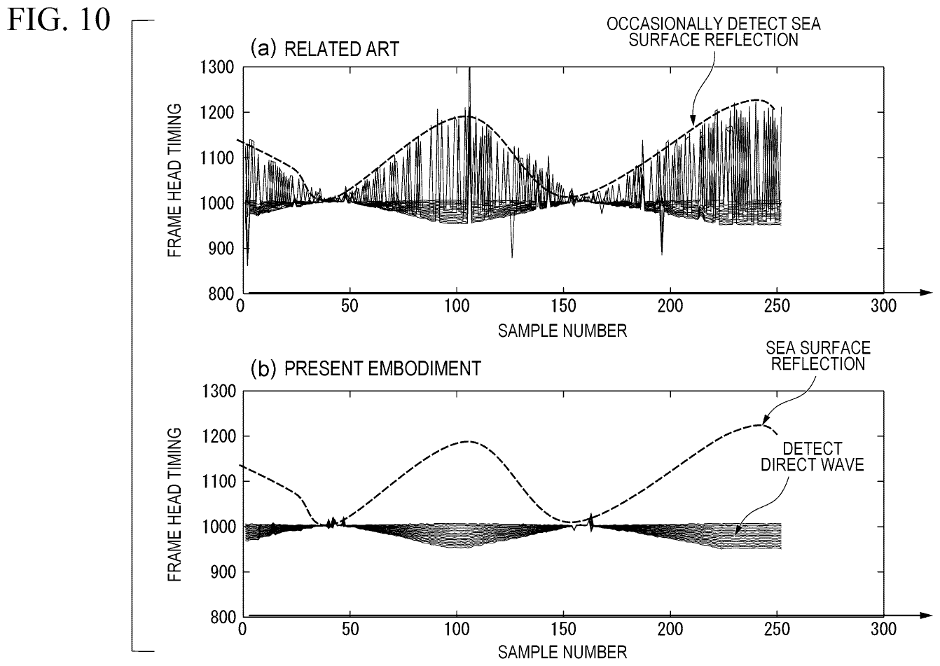

FIG. 10 is a diagram illustrating an estimated value of the frame head timing. In FIG. 10, the frame head timing estimated value of all the channels are plotted in an overlapping manner. The horizontal axis represents a recorded sample number, and the vertical axis represents a head timing. As illustrated in FIG. 10(a), in the conventional technology, the frame head timing is often mistaken as an arrival position of the sea-surface reflected wave W′. On the other hand, as illustrated in FIG. 10(b), no error occurs in the present embodiment, and the estimation accuracy is obviously improved.

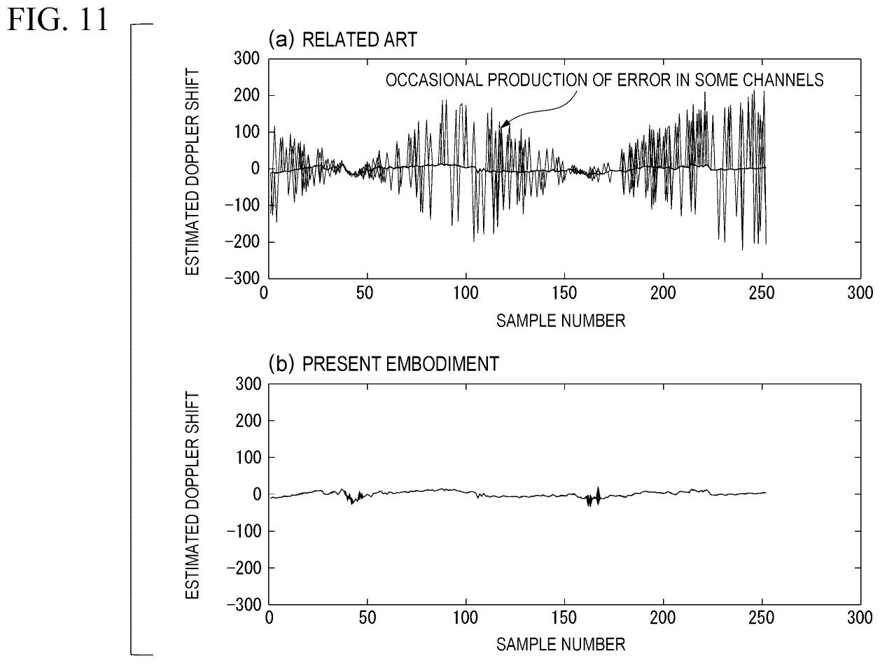

FIG. 11 is a diagram illustrating Doppler estimated value. In FIG. 11, the Doppler estimated value of all the channels are plotted in an overlapping manner. As illustrated in FIG. 11(a), in the conventional technology, erroneous estimation sometimes occurs at some channels. For example, a receiver of the conventional technology erroneously estimates a physical Doppler shift of ±7.28 Hz as hundreds of Hz. However, as illustrated in FIG. 11(b), such erroneous estimation does not occur in the receiver 1 of the present embodiment, and the accuracy of Doppler estimation is obviously improved.

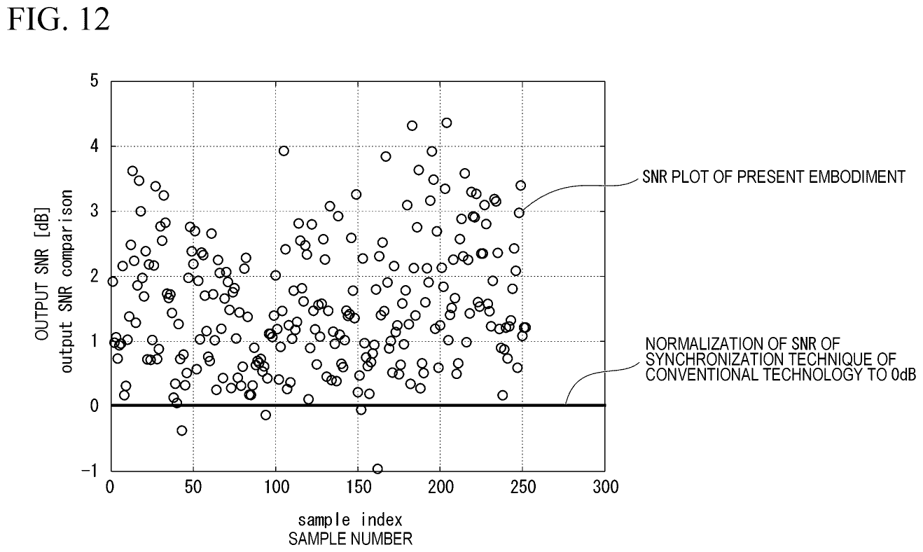

Finally, this means that the equalization performance is improved by improving the synchronization accuracy. FIG. 12 is a diagram illustrating an SNR characteristic in the output of the equalizer. The horizontal axis represents the recorded sample number. The vertical axis represents a difference value between the SNR (dB value) in the output of the equalizer 5 in a case of synchronization using the estimation result of the present embodiment and the SNR (dB value) in a case of synchronization using the estimation result of the conventional technology. As illustrated in FIG. 12, most samples have 0 dB or higher (SNR of the present embodiment >SNR of the conventional technology), and the equalization performance of the present embodiment is higher than the equalization performance of the conventional technology. According to the present embodiment, the accuracy of the Doppler estimation and the frame detection position is improved, and as a result, the equalization performance is improved.

According to the above-described embodiments, the receiving apparatus includes the plurality of reception units, a synchronization device, and the equalizer. The plurality of reception unit receive signals of different channels, respectively. The plurality of reception units correspond to, for example, the wave receivers 2-1 to 2-N of the embodiment. The synchronization device includes detecting units, a calculation unit, correcting units, a Doppler estimation unit, and offsetting units. The synchronization device corresponds to, for example, the synchronization unit 4 of the embodiment. The detecting units correspond to, for example, the first correlator 4111, the second correlator 4112, the preamble position detecting unit 4113, and the postamble position detecting unit 4114 of the embodiment. The calculation unit corresponds to, for example, the subtractor 4115 of the embodiment. The correcting units correspond to, for example, the first outlier correcting unit 412 and the second outlier correcting unit 413 of the embodiment. The Doppler estimation unit corresponds to, for example, the Doppler estimation unit 414 of the embodiment. The offsetting units correspond to, for example, the resampling unit 42 and the phase rotation unit 43 of the embodiment. The detecting units detect a position of the first sequence and a position of the second sequence in the received signal of each of the plurality of channels received by the plurality of reception units. The calculation unit calculates, for each of the plurality of channels, a time period required to receive a predetermined part of the received signal on the basis of the detected position of the first sequence and the detected position of the second sequence. The correcting units perform a correcting process of correcting one or both of an outlier included in the position of the first sequence estimated for each of the plurality of channels and an outlier included in the time period calculated for each of the plurality of channels. The Doppler estimation unit estimates a Doppler shift by using the time period after the correcting process for each of the plurality of channels. The offsetting units offset the received signal by using the estimated Doppler shift for each of the plurality of channels and outputs the received signal divided on the basis of the position of the first sequence after the correcting process. The equalization unit performs an equalizing process by using the received signal of each of the plurality of channels output from the offsetting units.

The received signal may include a payload sandwiched between a preamble portion and a postamble portion. The first sequence is a preamble included in the preamble portion, and the second sequence is a postamble included in the postamble portion. The predetermined part of the received signal is from a predetermined position of the preamble portion to a predetermined position of the postamble portion.

The correcting units may correct the outlier using the robust regression method. The robust regression method used by the correcting units is one or more of an iterative weighted least square method, a least median method, a random sample consensus method, convex relaxation, a greedy method for a purpose of lp norm minimization, a proximity gradient method for a purpose of lp norm minimization, logistic regression, ridge regression, and LASSO regression, for example.

The reception unit may be the wave receiver that receives a sound wave propagating in water.

As described above, the embodiments of the present invention have been described in detail with reference to the drawings. On the other hand, the specific configuration is not limited to the embodiments and includes design and the like without departing from the gist of the present invention.

### REFERENCE SIGNS LIST

1 Receiver
2-1 to 2-N Wave receiver
3-1 to 3-N ADC
4-1 to 4-N, 4-n Synchronization unit
5 Equalizer
7 Sea surface
8 Wave transmitter
41 Estimation unit
42 Resampling unit
43 Phase rotation unit
87 Receiver
88 Wave receiver
90 Synchronization unit
91 Estimation unit
92 Resampling unit
93 Phase rotation unit
99 Equalizer
411-1 to 411-N Primary estimation unit
412 First outlier correcting unit
413 Second outlier correcting unit
414 Doppler estimation unit
911 First correlator
912 Second correlator
913 Preamble position detecting unit
914 Postamble position detecting unit
915 Subtractor
916 Doppler estimation unit
4111 First correlator
4112 Second correlator
4113 Preamble position detecting unit
4114 Postamble position detecting unit
4115 Subtractor

1. A receiving method comprising:
detecting a position of a first sequence and a position of a second sequence in a received signal of each of a plurality of channels received by a plurality of receivers;
calculating, for each of the plurality of channels, a time period which has been required to receive a predetermined part of the received signal, based on the detected position of the first sequence and the detected position of the second sequence;
performing a correcting process of correcting one or both of an outlier included in the position of the first sequence having been detected for each of the plurality of channels and an outlier included in the time period having been calculated for each of the plurality of channels;
estimating Doppler shift by using the time period after the correcting process for each of the plurality of channels; and
offsetting the received signal by using the Doppler shift having been estimated for each of the plurality of channels and outputting the received signal divided based on the position of the first sequence after the correcting process to an equalizer.

2. The receiving method according to claim 1, wherein
the received signal includes a payload sandwiched between a preamble and a postamble,
the first sequence is a preamble data included in the preamble,
the second sequence is a postamble data included in the postamble, and
the predetermined part of the received signal is from a predetermined position of the preamble to a predetermined position of the postamble.

3. The receiving method according to claim 1, wherein
one or both of the outlier included in the position of the first sequence and the outlier included in the time period are is corrected using a robust regression method.

4. The receiving method according to claim 3, wherein
the robust regression method is one or more of an iterative weighted least square method, a least median method, a random sample consensus method, convex relaxation, a greedy method for a purpose of lp norm minimization, a proximity gradient method for a purpose of Ip norm minimization, logistic regression, ridge regression, and LASSO regression.

5. The receiving method according to claim 1, wherein
each of the plurality of receivers receives a sound wave propagating in water.

6. A synchronization device comprising:
a detector that detects a position of a first sequence and a position of a second sequence in a received signal of each of a plurality of channels received by a plurality of receivers;
a calculator that calculates, for each of the plurality of channels, a time period which has been required to receive a predetermined part of the received signal, based on the detected position of the first sequence and the detected position of the second sequence;
a correcting circuitry that performs a correcting process of correcting one or both of an outlier included in the position of the first sequence having been detected for each of the plurality of channels and an outlier included in the time period having been calculated for each of the plurality of channels;
a Doppler estimation circuitry that estimates Doppler shift by using the time period after the correcting process for each of the plurality of channels; and
an offsetting circuitry that offsets the received signal by using the Doppler shift having been estimated for each of the plurality of channels and outputs the received signal divided based on the position of the first sequence after the correcting process to an equalizer.

7. A receiving apparatus comprising:
a plurality of receivers that receive signals of different individual channels;
a detector that detects a position of a first sequence and a position of a second sequence in a received signal of each of a plurality of the channels, the received signals is each of the signals having been received by the plurality of receivers;
a calculator that calculates, for each of the plurality of channels, a time period which has been required to receive a predetermined part of the received signal, based on the detected position of the first sequence and the detected position of the second sequence;
a correcting circuitry that performs a correcting process of correcting one or both of an outlier included in the position of the first sequence having been detected for each of the plurality of channels and an outlier included in the time period having been calculated for each of the plurality of channels;
a Doppler estimation circuitry that estimates Doppler shift by using the time period after the correcting process for each of the plurality of channels;
an offsetting circuitry that offsets the received signal by using the Doppler shift having been estimated for each of the plurality of channels and outputs the received signal divided based on the position of the first sequence after the correcting process; and
an equalizer that performs an equalizing process by using the received signal of each of the plurality of channels output from the offsetting circuitry.
